(19) United States
(12) Patent Application Publication
(10) Pub. No.: US 2024/0144677 A1
(43) Pub. Date: May 2, 2024

(54) MOBILE APPLICATION CAMERA ACTIVATION AND DE-ACTIVATION BASED ON PHYSICAL OBJECT LOCATION

(71) Applicant: Humans, Inc (dba Flip Fit), Inglewood, CA (US)

(72) Inventor: NOORULDEEN A ARIF ALAARIF, Los Angeles, CA (US)

(21) Appl. No.: 17/979,603

(22) Filed: Nov. 2, 2022

(51) Int. Cl. G06V 20/40; G06Q 10/083; G06Q 10/0837; G06Q 30/018; G06V 10/70; G06V 10/74; G06V 10/774; G06V 10/94; G11B 27/10; G11B 27/34; H04N 23/61

(52) U.S. Cl. CPC G06V 20/40; G06Q 10/0837; G06Q 10/0838; G06Q 30/0185; G06V 10/74; G06V 10/774; G06V 10/87; G06V 10/945; G11B 27/102; G11B 27/34; H04N 23/61

(57) ABSTRACT

A device determines that a physical object is to be presented, by a presenter, in a streaming video. The device identifies a set of physical objects that are confirmed as having been delivered to a physical address of the presenter, accesses an image recognition model that is trained using the set of physical objects, and applies the image recognition model to the streaming video. The device determines, based on output from the image recognition model, whether the streaming video includes the physical object. In response to determining that the physical object is part of the set of physical objects, the device permits the physical object to be presented in the streaming video, and in response to determining the physical object is not part of the set of physical objects, the device blocks the physical object from being presented in the streaming video.

### TECHNICAL FIELD

The disclosure generally relates to the field of data integrity, and more particularly relates to ensuring integrity of image and video data by restricting access to a camera feature and/or video streaming capabilities of a mobile device application unless a physical object on which data is being collected is at a predetermined physical location.

### BACKGROUND

Online applications that include camera features enable users to capture images and then annotate those images with metadata without restraint. While this may be helpful for some types of applications, such as social media applications that may harvest annotations, as well as other metadata and other features from the images to improve a graph, this may be detrimental for the accurate tracking of data rooted in tangible real-world objects. Moreover, where live video is what is captured, current mechanisms of verifying the integrity of annotations of that live video or authenticity of what is being portrayed in the live video are inaccurate or unduly delayed due to fraud detection mechanisms requiring too much computational power to detect such fraud in time to stop the live video from streaming. This may result in fraudulent representations in live video going unchecked.

### SUMMARY

One embodiment of a disclosed system, method and computer readable storage medium includes a mechanism for detecting fraudulent annotations of physical objects in live video. For example, an application might be used to initiate a live video feed where a presenter purports to present a physical object, such as an item of clothing. Data may be captured by the application about the live video, such as audio data or typed data that purports that a certain physical object is displayed. The data might be compromised if the video does not accurately and completely display the physical object, be it due to user error (e.g., video is of a poor angle or in poor lighting), or due to fraudulent use (video is of different clothing, includes lewd imagery, and the like). To prevent the data from being compromised, the systems and methods disclosed herein block presentation of a physical object in a live video where the live video is determined to not include the purported physical object. In order to determine whether the live video includes the purported physical object, physical objects known to have been delivered to a physical address of the presenter are determined, and one or more models trained on those physical objects are used to determine whether the live video contains a match.

To this end and others, in an embodiment, a physical object provider determines that a physical object is to be presented, by a presenter, in a streaming video. The physical object provider identifies a set of physical objects that are confirmed as having been delivered to a physical address of the presenter, accesses an image recognition model that is trained using the set of physical objects, and applies the image recognition model to the streaming video. The physical object provider determines, based on output from the image recognition model, whether the streaming video includes the physical object. In response to determining that the physical object is part of the set of physical objects, the physical object provider permits the physical object to be presented in the streaming video, and in response to determining the physical object is not part of the set of physical objects, the physical object provider blocks the physical object from being presented in the streaming video.

### BRIEF DESCRIPTION OF DRAWINGS

The disclosed embodiments have other advantages and features which will be more readily apparent from the detailed description and the accompanying figures (or drawings). A brief introduction of the figures is below.

Figure (FIG. 1 illustrates one embodiment of a system embodiment including an application of a client device that toggles activation of a camera function and selectively enables live video streaming based on location of a physical object.

FIG. 2 illustrates one embodiment of exemplary modules of the application.

FIG. 3 illustrates one embodiment of exemplary modules of a physical object provider.

FIG. 4 is a block diagram illustrating components of an example machine able to read instructions from a machine-readable medium and execute them in a processor (or controller).

FIG. 5 illustrates one embodiment of an exemplary user interface with an indication that access to the camera by the application is de-activated.

FIGS. 6A-6B illustrate one embodiment of an exemplary user interface where access to the camera by the application is activated, and tagging is performed.

FIG. 7 illustrates one embodiment of an exemplary flow chart for selectively activating access by an application to a camera of a mobile device.

FIG. 8 illustrates one embodiment of an exemplary live video stream of objects facilitated by the physical object provider.

FIG. 9 illustrates one embodiment of an exemplary flow chart for selectively enabling live streaming of a presentation of a physical object based on fraud verification.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Selective Activation and De-Activation of a Camera Function of an Application

FIG. 1 illustrates one embodiment of a system embodiment including an application of a client device that toggles activation of a camera and selectively enables live video streaming based on location of a physical object. System 100 includes client device 110, network 120, physical object provider 130, and physical object delivery service 140. Client device 111 may be any device facing an end user. Examples of client devices include mobile devices like smart phones and tablet computers, laptops, personal computers, smartwatches, internet-of-things (IoT) devices, and any other device with, or capable of being coupled to, a display with which the user can interact to cause data to be transmitted over a network. Network 120 may be any data network, such as the Internet or any other network that facilitates data communication between client device 111 and a server.

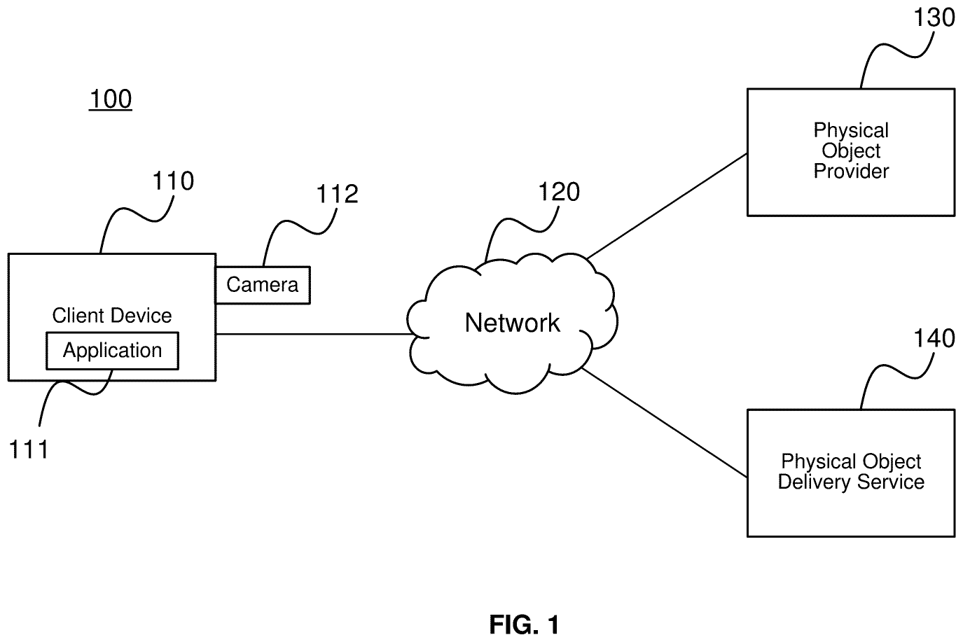

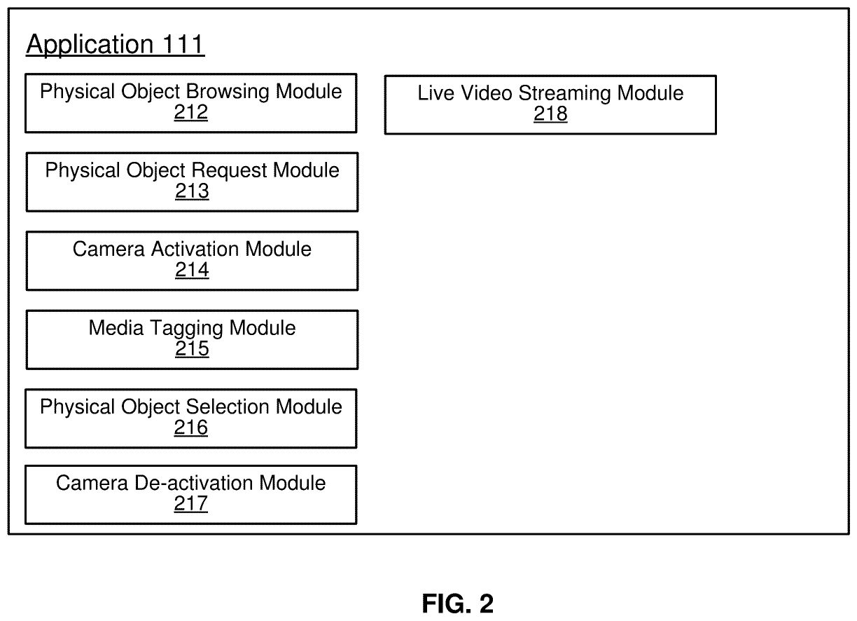

Client device 110 includes application 111 and camera 112. Application 111 may be downloaded from physical object provider 130 or through a third party that hosts downloads of application 111 (e.g., an app store). Application 111 may alternatively be a browser that accesses functionality from a web server hosted by physical object provider 130, rather than a dedicated stand-alone application installed on client device 110. In brief, application 111 enables a user of client device 110 to browse images of physical objects and annotate the browsed images. For example, if the physical objects include clothing, application 111 might display images of the clothing, and the user might indicate whether he or she likes or dislikes the clothing. Application 111 also enables a user of client device 110 to live stream video where physical objects provided by physical object provider 130 are presented, and annotate the video for replay (or cause the video to be annotated). Further details about application 111 will be described below with respect to FIG. 2.

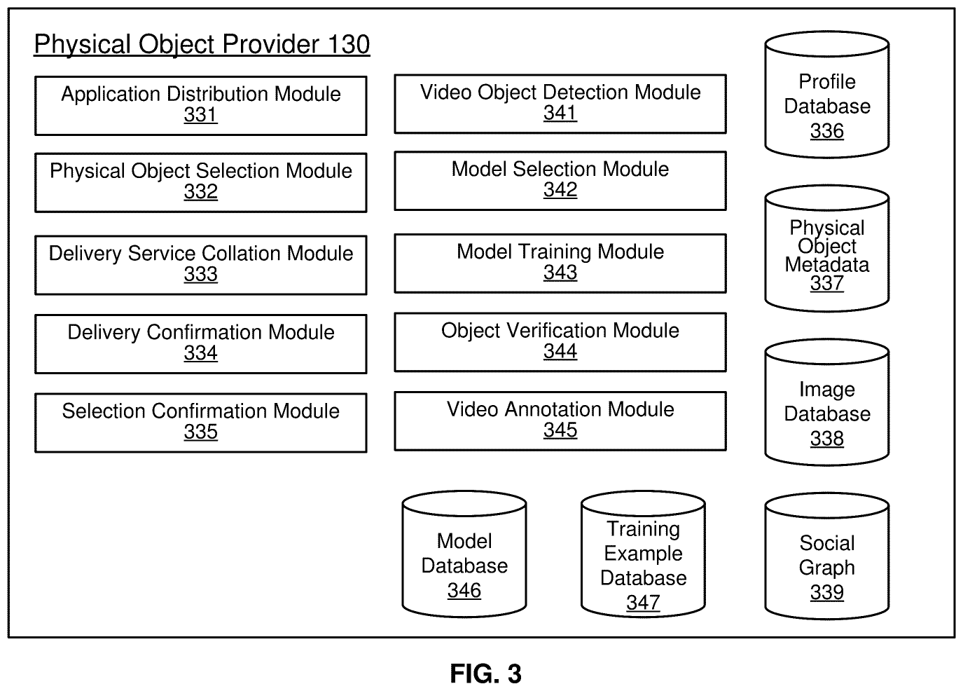

Physical object provider 130 is a service that facilitates the browsing, selection, and provision of physical objects. Physical object provider 130 transmits images of physical objects to application 111 for browsing by the user of client device 110, and logs user interactions with those images. Physical object provider 130 may receive a request to provide physical objects to an address of a user of client device 110, and may responsively select physical objects and coordinate delivery of those physical objects via physical object delivery service 140. Physical object provider 130 hosts live video streaming and replays of live video streaming, where the live videos originate from application 111 of various client devices 110 of users. Physical object provider 130 provides for fraud detection and prevention within those live video streams. Further details about physical object provider 130 are described below with respect to FIG. 3.

Physical object delivery service 140 is a service that delivers physical objects from a source location (e.g., a warehouse associated with physical object provider 130) to a destination location (e.g., the address of the user of client device 111), and that returns some or all of the physical objects from the destination location to the source location. While only one client device, physical object provider, and physical object delivery service are depicted, this is for convenience in illustration; any number of any of these components is within the scope of the disclosure. The components of physical object provider 130 may be distributed over one or more servers. Physical object delivery service 140 may be a third-party parcel delivery service operated separately from physical object provider 130.

FIG. 2 illustrates one embodiment of exemplary modules of the application. Application 111 includes physical object browsing module 212, physical object request module 213, camera activation module 214, image tagging module 215, physical object selection module 216, camera de-activation module 217, and live video streaming module 218. The modules depicted in FIG. 2 are merely exemplary; fewer or more modules may be included to execute the functions described with respect to application 111.

Application 111 will now be described where the physical objects referred to herein are clothing. While this example will be pervasive throughout the remainder of the disclosure, any other tangible, physical object may be used in place of clothing wherever mentioned. Application 111 may be initialized by requesting various biographical information about the user of client device 110 to set up an account for that user. The biographical information may be any information that is descriptive of the user, such as age, sex, weight, sizing (e.g., waist, bust, height, length, etc.), race, ethnicity, and so on. Application 111 may also be initialized by additional information, such as location of residence. Application 111 may also be initialized by information of other applications used by the user, such as social media applications, medial/video consumption and publication applications, and so on. Information obtained during initialization may be transmitted by application 111 to physical object provider 130, which may store the information in a profile for the user.

Physical object browsing module 212 outputs media (e.g., images and/or videos) for display on client device 111. The media may depict images of various clothing available from physical object provider 130, as they are worn by various individuals. The media may depict other objects available from object provider 130 (e.g., beauty products, sports equipment, consumable matter, and so on), and may do so in isolated pages, or embedded in images and/or videos (e.g., showing icons corresponding to objects presented in a video). In an embodiment, physical object browsing module 212 limits the media shown to those of users wearing the clothing who are connected to the user of client device 110 by way of a social graph. The social graph will be described in further detail below with respect to FIG. 3. Physical object browsing module 212 detects interactions of the user with the media, such as the indicia that the user likes or dislikes the image, that the user has interacted with an icon associated with the media (e.g., an icon for advancing to a portion of a video that includes the object), and so on. Physical object browsing module 212 transmits this interaction information to physical object provider 130, which may store the interaction information in a profile for the user.

Physical object request module 213 outputs an interface to the user whereby the user may request that physical objects, such as clothing, be delivered to the user. Responsive to receiving a request, physical object request module 213 transmits a request to physical object provider 130 to select physical objects (e.g., clothing based on images of clothing that the user indicated he or she liked) be mailed to an address indicated in the profile of the user. Requests may be solicited by physical object request module 213. For example, when a user is viewing media that portrays an object provided by physical object provider 130, physical object request module 213 may cause a selectable icon to be displayed to the user that, when selected, leads to an interface for requesting the object. The manner in which the physical objects are selected is described with reference to the physical object selection module 332 depicted in FIG. 3 below.

While application 111 has a built-in function to launch camera 112 and cause media from camera 112 to be uploaded to physical object provider 130, this function may be disabled until camera activation module 214 enables the function. Camera activation module 214 awaits a signal from physical object provider 130 that the camera should be activated. The basis on which camera activation module 214 enables activation of the camera function of application 111 is described in further detail with respect to FIG. 3.

After the camera is activated, the application 111 captures media using camera 112 of client device 110. In an embodiment, when an image is captured, image tagging module 215 prompts the user to indicate which object, of the physical objects mailed to the user, is within the image. The prompt may include a list of all of the objects that were mailed to the user, from which the user may select an identifier of the object depicted in the figure. In an embodiment, verification of the selection by the user is performed, whereby a model, such as a pattern recognition or machine learning model takes the image and the identifier selected by the user and outputs a result of whether the image and the identifier match. This verification may be performed by application 111 before upload, or by physical object provider 130.

In an embodiment, video may be captured where an object is purported to be presented. Application 111 may perform analytics to determine whether the purported object is (1) in possession of the user, and (2) the actual object being presented. This will be described in further detail below with respect to FIG. 3, though the detail described with respect to physical object provider 130 as an actor in this regard may be equally performed in whole or in part by application 111.

In an embodiment, rather than image tagging module 215 having the user select which of the physical objects mailed to the user is within the media, media tagging module 215 feeds as input the media and a list of objects mailed to the user to a machine learning model, and receive as output indicia of which of the list of objects is within the media, and automatically tags the media with that output. The machine learning model may be trained using a training set having underlying signals (e.g., audio, images, image sequences) as labeled by whether those signals correspond to what is presented within the media. The machine learning model may detect that none of the objects in the list match the media. Where a verification process based on manual selection yields no match, or where an attempt at automatic tagging fails, media tagging module 215 may take corrective action.

Corrective action may include media tagging module 215 instructing that the user be prompted with a notification that the media does not match any objects that were mailed to the user, and requesting new media be captured. Media tagging module 215 may detect a reason why the media did not match (e.g., low brightness, poor angle of capture, etc.), and may output the reason to the user to inform an adjustment for obtaining acceptable media. Media tagging module 215 may determine the reason by inputting the media into a machine learning model trained to determine a reason why an image may be unacceptable, and may receive the reason as output (or a probability that each of candidate reasons apply as output, in which case the probabilities may be compared to a threshold and a candidate reason having a probability exceeding the threshold may be selected). The machine learning model may be trained using a training set of objects as labeled by conditions that render media unacceptable.

Image tagging module 215 may detect during a verification process or during an attempt at automatic tagging that the user is engaged in fraudulent behavior. This detection may be performed by inputting the media into a model (e.g., a pattern matching model or a machine learning model), which is trained to output whether the media likely corresponds to fraudulent behavior. For example, the model may be trained to detect patterns corresponding to lewd photographs, unauthorized advertisements, and the like. As another example, the model may be trained to detect, where a physical object is purported to be presented in a given video or portion of the video, whether that physical object is actually present in the video or portion. Responsive to detecting fraudulent behavior, image tagging module 215 may transmit an alert to an administrator of physical object provider 130, or may automatically disable application 111 at the client device 110 due to fraudulent behavior. Fraud detection and general object verification is described in further detail below with respect to activity performed by physical object provider 130, and where that description is made, it applies equally to activity performed in whole or in part by application 111.

After tagging the media, the media may be transmitted to other client devices 111 where other users of the physical object provider may be prompted by physical object browsing module 212 to indicate whether they like the media that the user uploaded. Following from the clothing example, the user may use this service to obtain feedback as to whether the clothing looks good on the user. Application 111 may enable the user to designate permissions on who can and cannot provide feedback (e.g., only friends connected to me in the social graph can see these images). Application 111 may enable the user to specifically request particular people provide feedback, which may in turn cause, on those users' applications, a push notification to populate that requests those users provide such feedback.

Camera 112 may remain active after tagging the media, thus enabling the user to upload, tag, and share additional media as desired. For example, the user may receive feedback stating “Looks good from the front! But maybe not the back, can you take a picture at another angle?” Where other users specifically request an additional media be uploaded, physical object provider 130 may instruct application 111 of those other users with a notification, such as a push notification, that the requested additional image has been uploaded.

Physical object selection module 216 may prompt the user to indicate which of the physical objects the user wishes to keep, and which of the physical objects the user wishes to return to physical object provider 130. The user indicates which objects he or she will keep or return and selects a selectable option provided by physical object selection module 216. Physical object selection module 216 may perform this prompt responsive to detecting that feedback has been received and/or responsive to detecting that a predetermined amount of time has elapsed.

Camera de-activation module 217 detects the selection of the selectable option to finalize the selections of what will be kept or returned. Responsively, camera de-activation module 217 de-activates access by application 111 to camera 112. Camera de-activation module 217 may de-activate access by application 111 to camera 112 for other reasons. For example, camera de-activation module 217 may detect that a predetermined amount of time has elapsed since camera 112 was activated, and may responsively de-activate access by application 111 to camera 112. This may occur, for example, where a user is delinquent in trying on and capturing images of clothing mailed to the user. As another example of a de-activation reason, camera de-activation module 217 may receive instructions based on detection that one or more of the physical objects sent to the user have been shipped back to physical object provider 130 (e.g., using delivery confirmation module 334, as described below), and may responsively de-activate access by application 111 to camera 112.

FIG. 3 illustrates one embodiment of exemplary modules of a physical object provider. As depicted in FIG. 3, physical object provider 130 includes application distribution module 331, physical object selection module 332, delivery service collation module 333, delivery confirmation module 334, selection confirmation module 335, profile database 336, physical object metadata database 337, image database 338, social graph 339, video object detection module 341, model selection module 342, model training module 343, object verification module 344, video annotation module 345, model database 346, and training example database 347. The modules and databases of physical object provider 130 are merely exemplary; more or fewer modules and databases may be implemented by physical object provider 130 to effectuate the operations described herein. Activity described with respect to any module of physical object provider 130 may occur in whole or in part on an application 111 through distributed processing, and is described as performed by physical object provider 130 herein for convenience in illustrating functionality of what is disclosed.

Application distribution module 331 transmits an application for download to client device 110. Application distribution module 331 may additionally transmit updates, notifications, and the like, for the application to client devices on which the application is installed. In an embodiment, application distribution module 331 provides the application to a third party repository, such as an app store, from which users of client devices can download the application. In an embodiment, the application may be accessed by way of a browser, where the application may be accessible by directly logging into a portal for physical object provider 130, or by accessing other web pages where functionality provided by physical object provider 130 is embedded.

Physical object selection module 332 selects objects to provide to the user upon receiving a request for objects (e.g., from physical object request module 213 of application 111). Physical object selection module 332 selects objects for the user based on the biographical information of the user, as well as the interaction information that the user had while browsing images, all of which may be stored to a user profile in profile database 336. Physical object selection module 332 uses heuristics and/or machine learning models to match the user profile information to physical objects (e.g., clothing that a user is likely to enjoy in a variety of styles). The selected objects are packaged and transferred to physical object delivery service 140, which mails the physical objects to the user at an address indicated in the profile of the user.

In an embodiment, physical object selection module 332 determines interest from a user for given objects based on that user's consumption of media that features the given objects. For example, where a video includes given objects, users may interact with that video and/or selectable options within that video to expressly request those objects, or physical object selection module 332 may determine implicitly that the user is interested in the given objects. An example of implicit interest may be where physical object selection module 332 inputs signals from the user's interactivity with a video (e.g., time spent playing back video featuring an object, repeated playbacks, cookies and access to links indicating the user has continued viewing media (e.g., web pages) about the object, and so on) into a machine learning model, where the machine learning model is trained to output whether the user is interested in the given object (e.g., a percentage is output, and where that percentage exceeds a threshold, the user is deemed to be interested).

Delivery service collation module 333 determines whether the selected physical objects have arrived at the address of the requesting user. In an embodiment, delivery service collation module 333 performs this determination by receiving a notification from physical object delivery service 140 that the object has been delivered (e.g., which may occur automatically when a symbol, such as a bar code, is scanned by the delivery service). This notification may be received by way of a dedicated application programming interface (API) that facilitates communication between physical object provider 130 and physical object delivery service 140. Delivery confirmation module 334 determines, based on output from delivery service collation module 333, that the requested objects have reached the address of the user, and transmits an instruction to application 111 to execute camera activation module 214.

Selection confirmation module 335 receives the selections of what the user has chosen to keep, and what the user has chosen to return to physical object provider 130. Selection confirmation module 335 may, responsive to receiving the selections, instruct application 111 to execute camera de-activation module 217. Instructions to execute de-activation module 217 may be sent to application 111 for other reasons as well. For example, physical object provider 130 may determine that a predetermined amount of time has elapsed since a time of delivery, and may responsively instruct application 111 to execute de-activation module 217. Other reasons for such instruction may include detection of fraudulent behavior, failure to pay for prior selected items, and the like.

Profile database 336 stores profile information about users, such as biographical information, interaction information, and the like, as described above with respect to FIGS. 1-2.

Physical object metadata database 337 stores information received with respect to a physical object. The information may be aggregated preference information received from various users while browsing the images of the physical objects, and may include attributes of the users who provided the preference information. For example, physical object metadata database 237 may store information indicating whether users in a particular part of the world like or dislike an image. Information in physical object metadata database 337 may be used to train machine learning models that are used to recommend certain physical objects to users. While not depicted, an administrator of physical object selection module may execute a module of physical object provider 130 to output a map of some or all of the world, with an overlay on top of the map indicating, for a selected product, whether people like or dislike a product. The locations on the map may be selected based on the address of the user who uploaded the image. By selectively activating and de-activating camera 112 of the client device for use with application 111 to cause images to be uploaded, the integrity of the data of physical object metadata database 337 is preserved in a manner that guarantees the accuracy of the location data when producing such a map or similar user interface. Physical object provider 130 may refine selections made by physical object selection module 332 on the basis of the data of physical object metadata database 337.

Image database 338 stores the images in connection with their individual metadata. The images may be retrieved for browsing by a given application 111 of a given client device. Social graph 339 maintains connections between the user and other users. Social graph 339 may be stored by physical object provider 130, or may be accessed from a third-party service.

In some scenarios, presenters of streaming videos present content within the videos that relates to physical objects provided by physical object provider 130. This content may include reviews of the physical objects, influencer video where the presenter is using the physical object in an activity (e.g., wearing a brand's clothing while accomplishing a feat), or any other type of video. The video may be presented on a platform provided by physical object provider 130 (e.g., directly, or in video of the platform embedded within another platform), or on another platform. Where video is presented on another platform, an application protocol interface (API) may be established between physical object provider 130 and the other platform to enable functionality provided by physical object provider 130 described herein to occur, the API allowing for physical object provider 130 to provide instructions with respect to the video (e.g., to disable the video) to be received by the other platform.

When video is presented, video object detection module 341 determines that a physical object is to be presented, by a presenter, in a streaming video. In an embodiment, video object detection module 341 performs this determination by detecting audio input indicative of the physical object. For example, where the presenter states “And now I will present a review of [physical object name]”, video object detection module 341 may determine that the physical object is to be presented. Detecting audio input may be performed using natural language processing and/or voice-to-text algorithms.

In an embodiment, video object detection module 341 determines that a physical object is to be presented by using pattern recognition on frames of the streaming video. For example, video object detection module 341 may apply a pattern recognition model to frames of the streaming video for a certain set of physical objects. The certain set of physical objects may be limited to those objects known to be in possession of the presenter, may be physical objects that a user with profile characteristics of the presenter are likely to present, or nay be an entire universe of physical objects provided by physical object provider 130. Where the frames include a given physical object, video object detection module 341 may determine that the given physical object is to be presented.

In an embodiment, video object detection module 341 applies a machine learning model to signals from the streaming video. For example, video object detection module 341 applies as input any combination of signals from the streaming video such as the frames themselves, bounding boxes of physical objects portrayed within the frames, audio data, textual data transcribed from the data, and/or any other data derivable from the streaming video. Video object detection module 341 receives as output from the machine learning model probabilities of any given physical object being portrayed, and may compare those probabilities to a threshold where when a given probability exceeds the threshold, video object detection module 341 determines that that given physical object is to be presented.

Video object detection module 341 identifies a set of physical objects that are confirmed as having been delivered to a physical address of the presenter. In an embodiment, this may occur responsive to determining that the physical object is to be presented in the streaming video. In an embodiment, physical object provider 130 may store data to profile database 336 in a profile of the presenter that indicates a current status of a set of physical objects that are confirmed as having been delivered to the physical address of the presenter, and video object detection module 341 may reference this profile. Video object detection module 341 may reference this profile responsive to determining that the physical object is to be presented in the streaming video, responsive to determining that the presenter is presenting any physical objects, or based on any other trigger. The data that indicates whether a given physical object has been delivered to the user (and, optionally, whether that given physical object has been returned) may be gathered by delivery confirmation module 334.

In an embodiment, identifying the set of physical objects that are confirmed as having been delivered to a physical address of the presenter includes video object detection module 341 determining, from a profile of the presenter (e.g., stored in profile database 336) physical objects that were ordered to the physical address of the presenter. Video object detection module 341 may then determine which of the physical objects ordered to the physical address of the presenter were delivered to the physical address of the presenter (e.g., using delivery confirmation module 334). Video object detection module 341 may assign the determined ones of the physical objects to the set of physical objects. As an example, video object detection module 341 may receive, by way of a dedicated application protocol interface established between the physical object provider and a delivery service responsible for delivery of the physical object to the physical address of the presenter, a notification that a parcel was delivered to the physical address of the presenter, and may correlate the notification to the determined ones of the plurality of physical objects. Moreover, to ensure that physical objects that leave possession of the presenter are not presented, video object detection module 341 may receive, by way of the dedicated application protocol interface, a return notification indicating that a return parcel was retrieved from the physical address of the presenter, may correlate the return notification to a subset of the set of physical objects (e.g., by updating profile database 336 with respect to the presenter's profile), and may modify the set of physical objects to exclude the subset.

Physical object provider 130 may seek to ensure that where video is presented that purports to include a physical object, that the video actually does include that physical object. However, naïve approaches to achieving this are impractical or impossible to implement. For example, a pattern recognition algorithm that seeks to match to all known physical objects requires a huge amount of processing power to compare what is presented to a huge amount of reference data. It is also impractical or impossible to train a machine learning model to recognize all physical objects, as the amount of training data required to train the model and the amount of processing power to run the model would prevent real-time or near real-time analysis of streaming video, and would lag substantially past the presentation of that streaming video. Moreover, such a model would be extremely noisy, as similar looking objects would all fit to a given detected object, and errors would occur.

To address this issue, model selection module 342 access image recognition model(s) that is/are trained using the set of physical objects. That is, the image recognition model(s) is/are only trained to detect physical objects that are in possession of the presenter, thus reducing computational complexity and required processing power substantially, and improving the accuracy of the image recognition model.

Accordingly, in an embodiment, accessing the image recognition model by model selection module 342 includes accessing a plurality of image recognition models (e.g., stored in model database 346), each trained to detect one object of the set of physical objects. For example, model training module 343 may train individual machine learning models, each trained to output a probability that a given physical object is present in the streaming video. Model training module 343 may perform this training by using training examples stored in training example database 347, the training examples each including one or more frames and/or sequences of frames and/or bounding boxes of physical object(s) within those frames as labeled by whether the frames and/or sequences include a depiction of a physical object. Model training module 343 may perform this training responsive to video object detection module 341 detecting a given physical object, or may perform the training in advance.

Model training module 343 may continually retrain models for detecting any given physical object as new feedback is received. For example, as streaming video is processed, frames from that streaming video may be incorporated into training data to retrain the models based on the new streaming video signals. Model selection module 343 may access one or more trained models for a detected physical object in streaming video and may apply signals from that streaming video to the accessed models to determine whether those physical objects are actually present in the streaming video. Using only models that pertain to detected physical objects that are purported to be presented substantially reduces processing power and increases accuracy in using a machine learning solution to detect fraud in real time or near real time for streaming media (e.g., live media).

In an embodiment, the plurality of image recognition models has models added to it responsive to their corresponding physical objects being delivered to the physical address of the presenter, and the plurality of image recognition models has models removed from it responsive to their corresponding physical objects being delivered away from the physical address of the presenter. That is, models may be individually trained for a given user based on physical objects that are confirmed to be in possession by the presenter, and may be stored in reference to the presenter's profile in profile database 336, where when the physical object is confirmed to be delivered away from the physical address of the presenter (e.g., when the presenter returns the physical object to physical object provider 130), the models are deleted from association with the presenter for whatever is delivered away. In an embodiment, models may be pre-trained without any association to any given user, and model selection module 342 may generate an association to the presenter's profile to respective pre-trained models as respective physical objects for which models are trained are determined to be in possession of the presenter.

In an embodiment, model training module 343 generates a training set using images of the set of physical objects as labeled by a positive outcome. That is, rather than using individual models for each given physical object, model training module 343 may train a machine learning model for the presenter using training examples for each physical object that is determined to be in possession of the presenter. Model training module 343 may perform this training in response to detecting a change in what the presenter is in possession of (e.g., responsive to determining that the given object has been delivered to and/or delivered away from the physical address of the presenter), or may perform this training in response to detecting that the presenter is purporting to present a physical object in live media. The training examples may include labels indicating the individual objects themselves, and/or may include labels indicating that the presenter is in fact in possession of the individual objects. Model selection module 342 applies this model to the streaming video to detect whether a given physical object that the user is in possession of is being presented. By doing this, physical object provider 130 further reduces processing power in only needing to detect whether an object that the presenter is in possession of is what is being presented, rather than needing to detect each individual physical object of the set.

Object verification module 344 determines, based on output from the image recognition model, whether the streaming video includes the physical object. In an embodiment, object verification module 344 reads binary output from the machine learning model as to whether the streaming video includes the physical object. In an embodiment, object verification module 344 receives output from the machine learning model that constitutes probabilities as to whether any of the set of objects are within the streaming video, and compares those probabilities to a threshold, where probabilities for physical objects that exceed the threshold lead to object verification module 344 concluding that those physical objects are within the streaming video. In response to determining that a physical object that is purported to be presented is part of the set of physical objects (that is, the physical objects in possession of the presenter), object verification module 344 permits the physical object to be presented in the streaming video. In response to determining the physical object that is purported to be presented is not part of the set of physical objects, object verification module 344 blocks the physical object from being presented in the streaming video. Blocking the physical object from being presented in the streaming video may include any combination of canceling the stream of the video, censoring the physical object during frames during which it is purported to be presented using a censor overlay, censoring audio during frames during which the physical object is purported to be presented, blocking the presenter from using physical object provider 130, and the like.

Video annotation module 345 may tag streamed video as physical objects that are presented are validated. For example, further in response to determining that the physical object is part of the set of physical objects, video annotation module 345 may tag a portion of the streaming video where the physical object is presented. The portion may correspond to a series of frames and/or a time range during the streaming video where the physical object is presented. More than one tag may be applied for a same portion (e.g., where the set of physical objects includes pants and a belt that are simultaneously being presented).

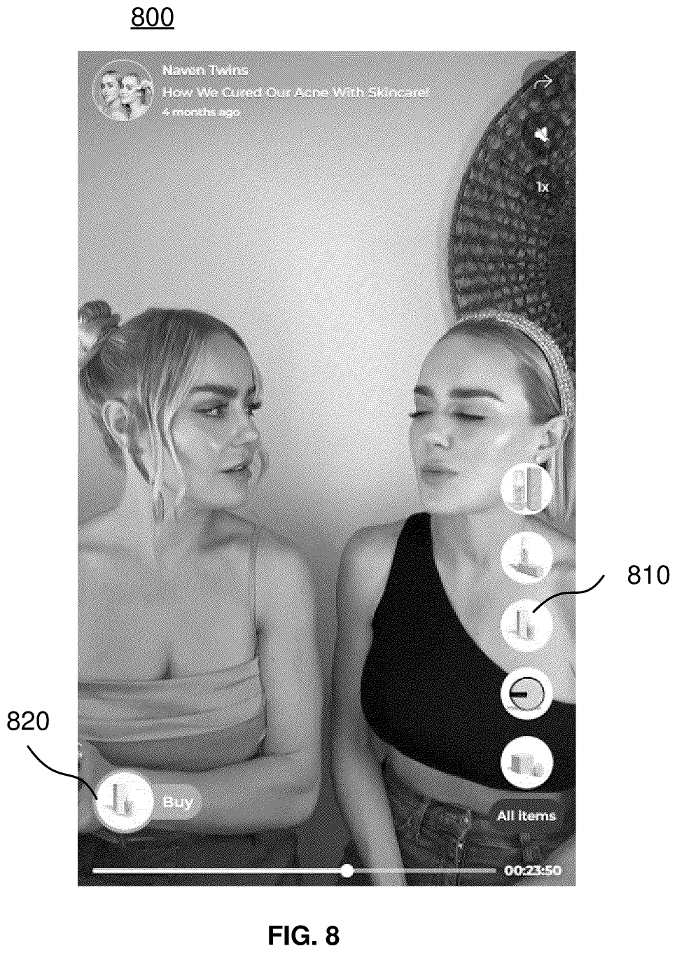

During a replay of the streaming video (e.g., after a live streaming when a video is posted as a social media publication), a selectable option corresponding to the physical object may be displayed based on the tag that, when selected, causes the replay of the streaming video to jump to the portion of the video. For example, turning briefly to FIG. 8, user interface 800 (e.g., of application 111) shows two presenters. The presenters presented during a live stream five physical objects, and selectable icons 810 correspond to each of the five physical objects. In response to detecting a selection of a given selectable option of selectable icons 810, playback of the video jumps to a portion where that physical object is presented.

Other options may be shown, such as selectable icon 820 to perform further activity with respect to a presently presented physical object. In an embodiment, user interface 800 may be embedded on a third party application. In response to selection of the selectable icon 820, a command may be received by way of an API between the third party application and physical object provider 130 that updates a profile of the user who performed the selection (e.g., adding that physical object to an online cart).

It bears noting that there may be multiple presenters in a streaming video. In such scenarios, the set of objects referred to herein for object verification may include objects in possession of any of the presenters. Moreover, metadata from social graph 339 may indicate relationships between users (e.g., users are in a familial relationship or cohabitate), and the set of objects may be expanded to include objects from users with relationships that satisfy a policy set by physical object provider 130 (e.g., to allow users of a same household to present physical objects in possession of any other user living in that household).

### Computing Machine Architecture

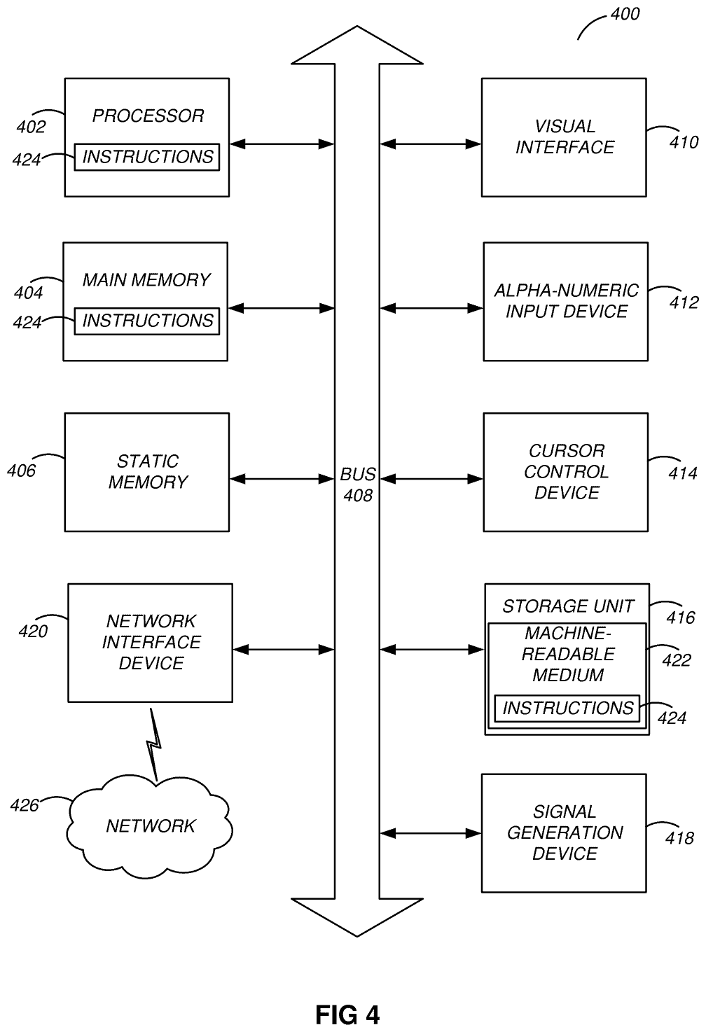

FIG. (FIG. 4 is a block diagram illustrating components of an example machine able to read instructions from a machine-readable medium and execute them in a processor (or controller). Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Exemplary Camera Activation/De-Activation User Interfaces

FIG. 5 illustrates one embodiment of an exemplary user interface with an indication that access to the camera by the application is de-activated. User interface 500 depicts a notification to the user that access by application 111 to camera 112 is de-activated. It is indicated that physical objects (in this case, clothes) must actually be received by the user before the user can access camera 112 to share images of the physical objects. User interface 500 may include additional features, such as a selectable option for navigating to an orders page that may provide information about an order or shipment of the physical objects. User interface 500 may be depicted responsive to a user navigating, using application 111, to a tool for using camera 112 to upload images of the user.

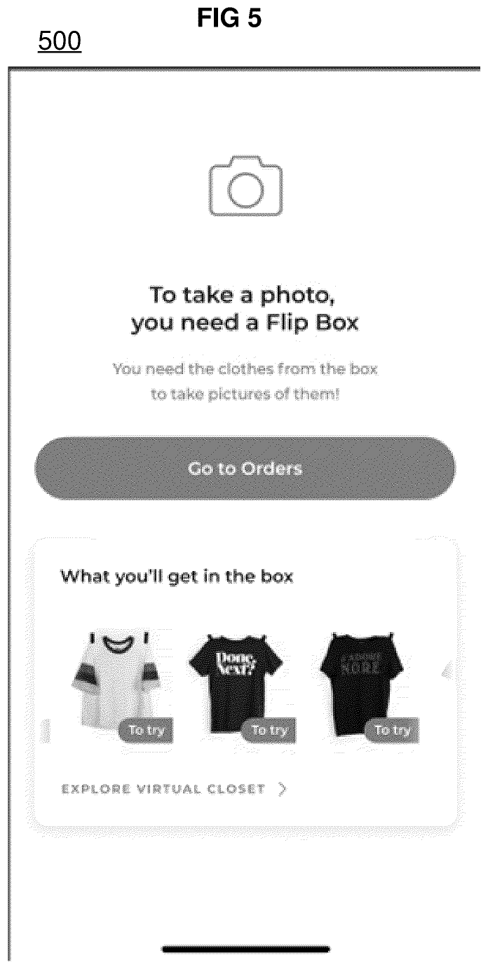

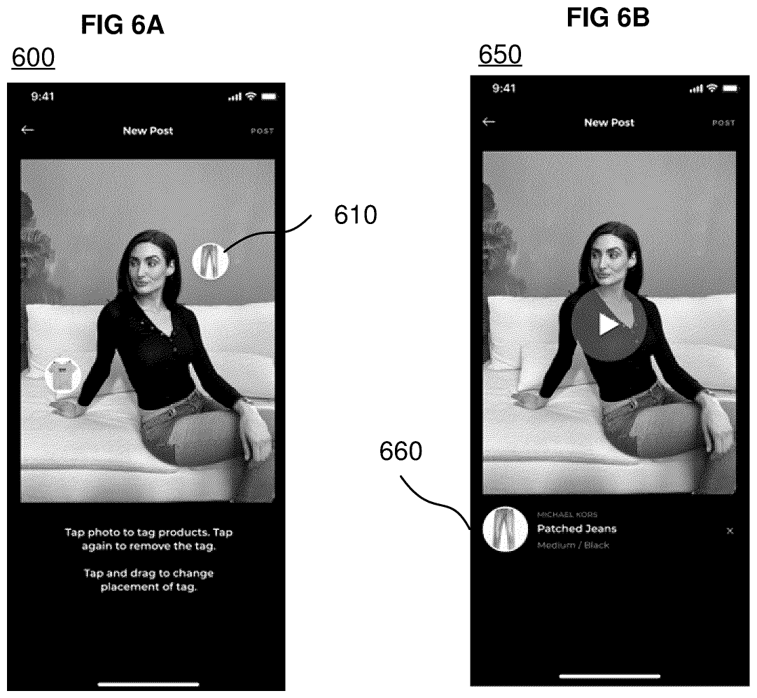

FIGS. 6A-6B illustrate one embodiment of an exemplary user interface where access to the camera by the application is activated, and tagging is performed. Following activation of the camera, the user is enabled to capture a picture of the physical objects—in this case, clothing being worn by the user, as depicted in user interface 600 of FIG. 6A. The user is then able to tag the photo to indicate what, in particular in the image, the user is seeking feedback on. In this case, the user may be seeking feedback on the pants she is wearing, and thus she may add tag 610 by tapping user interface 600, which may cause tag 610 to appear and depict a pair of pants. If the user is seeking feedback on multiple physical objects in the image, the user may add multiple tags, such as a shirt tag.

In an embodiment, the user may drag tag 610 (and any other tag) to a desired location of the image, and may have the image with tag 610 at the desired location published to other users. Alternatively, as depicted in user interface 650 of FIG. 6B, tags may be added by selecting the physical item that was ordered from a list, and having description 660 tagged to the image for publication with the image.

### Exemplary Data Flow for Selective Camera Activation

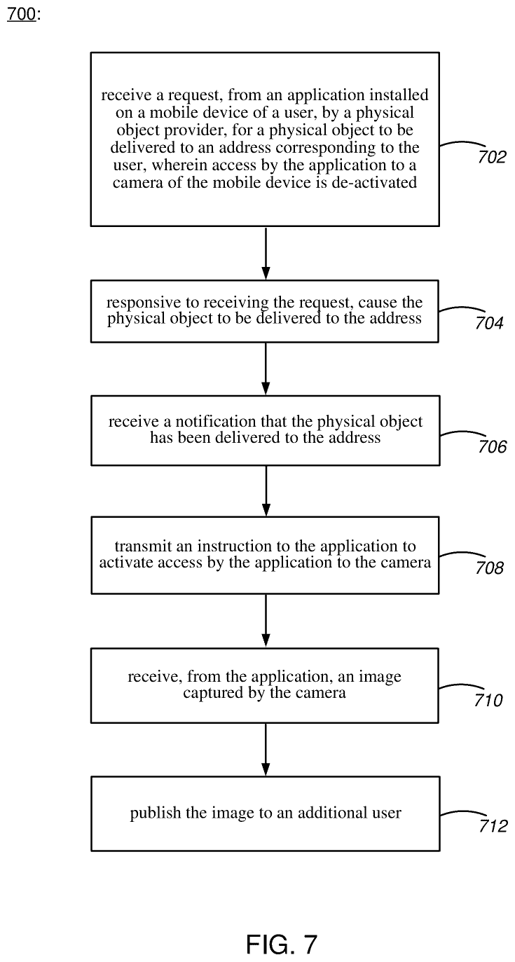

FIG. 7 illustrates one embodiment of an exemplary flow chart for selectively activating access by an application to a camera of a mobile device. Process 700 begins with a processor (e.g., of physical object provider 130) receiving 702 a request, from an application installed on a mobile device of a user (e.g., application 111 of client device 110), for a physical object to be delivered (e.g., by physical object delivery service 140) to an address corresponding to the user. At the time, access by the application to a camera of the mobile device (e.g., camera 112) is de-activated. Responsive to receiving the request, the processor causes 704 the physical object to be delivered to the address (e.g., by transmitting an instruction to physical object delivery service 140 to deliver the physical object to the address of the user).

The processor transmits 708 an instruction to the application to activate access by the application to the camera. For example, after the physical object is in possession of the user, the user is then able to access the camera to upload images of the physical objects. The processor receives 710, from the application, an image captured by the camera (e.g., as depicted in user interfaces 600 and 650), and publishes 712 the image to an additional user (e.g., subject to various verification performed on the image as described herein). Additional processes consistent with the functionality of the modules disclosed herein may be performed (e.g., a de-activation of the camera following a predetermined lapse of time, or following a selection of physical objects to return to physical object provider 130).

### Exemplary Video Streaming Physical Object Verification Data Flow

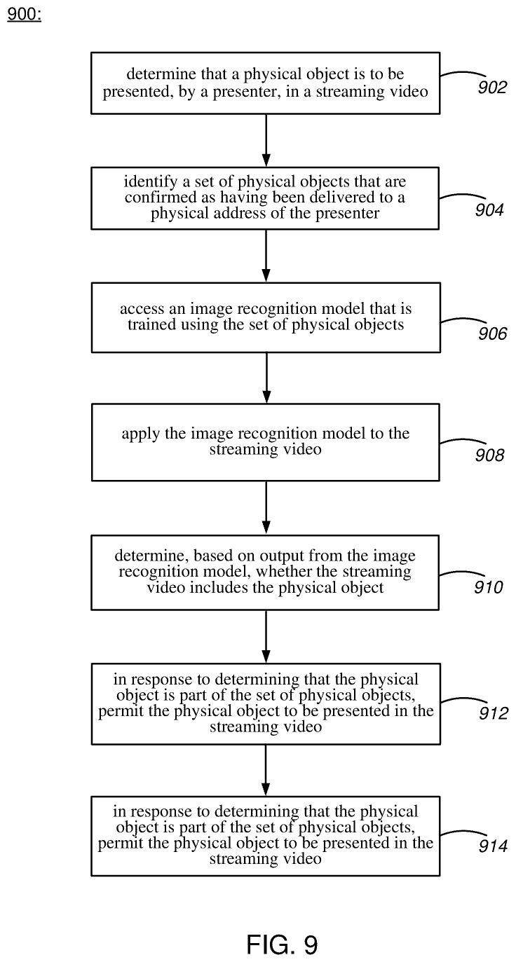

FIG. 9 illustrates one embodiment of an exemplary flow chart for selectively enabling live streaming of a presentation of a physical object based on fraud verification. Process 900 begins with physical object provider 130 commanding one or more processors (e.g., processor 402) to execute instructions (e.g., instructions 424) that cause various modules to perform operations. Physical object provider 130 determines 902 that a physical object is to be presented, by a presenter, in a streaming video (e.g., using video object detection module 341). Physical object provider 130 identifies 904 a set of physical objects that are confirmed as having been delivered to a physical address of the presenter (e.g., using delivery confirmation module 334). In an embodiment, presentation in the streaming video is disabled (e.g., because the camera is disabled) unless physical objects are previously determined to be in the possession of the presenter, as described in the foregoing.

Physical object provider 130 accesses 906 an image recognition model that is trained using the set of physical objects (e.g., selecting one or more models using model selection module 342, the training performed using model training module 343). Physical object provider 130 applies 908 the image recognition model to the streaming video. Physical object provider 130 determines 910, based on output from the image recognition model, whether the streaming video includes the physical object. In response to determining that the physical object is part of the set of physical objects, physical object provider 130 permits 912 the physical object to be presented in the streaming video, and, in response to determining the physical object is not part of the set of physical objects, physical object provider 130 blocks 914 the physical object from being presented in the streaming video.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for selectively activating and de-activating a camera function of an application through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
determining that a physical object is to be presented, by a presenter, in a streaming video;
identifying a set of physical objects that are confirmed as having been delivered to a physical address of the presenter;
accessing an image recognition model that is trained using the set of physical objects;
applying the image recognition model to the streaming video;
determining, based on output from the image recognition model, whether the streaming video includes the physical object;
in response to determining that the physical object is part of the set of physical objects, permitting the physical object to be presented in the streaming video; and
in response to determining the physical object is not part of the set of physical objects, blocking the physical object from being presented in the streaming video.

2. The method of claim 1, wherein identifying the set of physical objects occurs responsive to determining that the physical object is to be presented in the streaming video.

3. The method of claim 1, wherein the set of physical objects are additionally confirmed as still being present at the physical address of the presenter.

4. The method of claim 1, wherein the image recognition model is trained by:
generating a training set using images of the set of physical objects as labeled by a positive outcome; and
training the image recognition model to detect objects of the set of physical objects using the training set.

5. The method of claim 1, wherein the image recognition model is trained to detect a given object of the set of physical objects responsive to determining that the given object has been delivered to the physical address of the presenter.

6. The method of claim 5, wherein the image recognition model is retrained to avoid detecting the given object responsive to determining that the given object has been delivered away from the physical address of the presenter.

7. The method of claim 1, wherein accessing the image recognition model comprises accessing a plurality of image recognition models, each trained to detect one object of the set of physical objects, and wherein applying the image recognition model to the streaming video comprises applying each of the plurality of image recognition models to the streaming video.

8. The method of claim 7, wherein the plurality of image recognition models has models added to it responsive to their corresponding physical objects being delivered to the physical address of the presenter, and wherein the plurality of image recognition models has models removed from it responsive to their corresponding physical objects being delivered away from the physical address of the presenter.

9. The method of claim 1, wherein the streaming video is streamed to users by way of a provider of the physical object, and wherein identifying the set of physical objects that are confirmed as having been delivered to a physical address of the presenter comprises:
determining, from a profile of the presenter stored in a database of the provider of the physical object, a plurality of physical objects ordered to the physical address of the presenter;
determining which of the plurality of physical objects ordered to the physical address of the presenter were delivered to the physical address of the presenter; and
assigning the determined ones of the physical objects to the set of physical objects.

10. The method of claim 1, further comprising:
receiving, by way of a dedicated application protocol interface established between the physical object provider and a delivery service responsible for delivery of the physical object to the physical address of the presenter, a notification that a parcel was delivered to the physical address of the presenter; and
correlating the notification to the determined ones of the plurality of physical objects.

11. The method of claim 10, further comprising:
receiving, by way of the dedicated application protocol interface, a return notification indicating that a return parcel was retrieved from the physical address of the presenter;
correlating the return notification to a subset of the set of physical objects; and
modifying the set of physical objects to exclude the subset.

12. The method of claim 1, wherein, further in response to determining that the physical object is part of the set of physical objects, tagging a portion of the streaming video where the physical object is presented, and wherein, during a replay of the streaming video, a selectable option corresponding to the physical object is displayed that, when selected, causes the replay of the streaming video to jump to the portion of the video.

13. A non-transitory computer-readable medium comprising memory with instructions encoded thereon, the instructions, when executed by one or more processors, causing the one or more processors to perform operations, the instructions comprising instructions to:
determine that a physical object is to be presented, by a presenter, in a streaming video;
identify a set of physical objects that are confirmed as having been delivered to a physical address of the presenter;
access an image recognition model that is trained using the set of physical objects;
apply the image recognition model to the streaming video;
determine, based on output from the image recognition model, whether the streaming video includes the physical object;
in response to determining that the physical object is part of the set of physical objects, permit the physical object to be presented in the streaming video; and
in response to determining the physical object is not part of the set of physical objects, block the physical object from being presented in the streaming video.

14. The non-transitory computer-readable medium of claim 13, wherein identifying the set of physical objects occurs responsive to determining that the physical object is to be presented in the streaming video.

15. The non-transitory computer-readable medium of claim 13, wherein the set of physical objects are additionally confirmed as still being present at the physical address of the presenter.

16. The non-transitory computer-readable medium of claim 13, wherein the image recognition model is trained by:
generating a training set using images of the set of physical objects as labeled by a positive outcome; and
training the image recognition model to detect objects of the set of physical objects using the training set.

17. A system comprising:
memory with instructions encoded thereon; and
one or more processors that, when executing the instructions, are caused to perform operations comprising:
determining that a physical object is to be presented, by a presenter, in a streaming video;
identifying a set of physical objects that are confirmed as having been delivered to a physical address of the presenter;
accessing an image recognition model that is trained using the set of physical objects;
applying the image recognition model to the streaming video;
determining, based on output from the image recognition model, whether the streaming video includes the physical object;
in response to determining that the physical object is part of the set of physical objects, permitting the physical object to be presented in the streaming video; and
in response to determining the physical object is not part of the set of physical objects, blocking the physical object from being presented in the streaming video.

18. The system of claim 17, wherein identifying the set of physical objects occurs responsive to determining that the physical object is to be presented in the streaming video.

19. The system of claim 17, wherein the set of physical objects are additionally confirmed as still being present at the physical address of the presenter.

20. The system of claim 17, wherein the image recognition model is trained by:
generating a training set using images of the set of physical objects as labeled by a positive outcome; and
training the image recognition model to detect objects of the set of physical objects using the training set.
